(19) United States
(12) Patent Application Publication
(10) Pub. No.: US 2013/0145834 A1
(43) Pub. Date: Jun. 13, 2013

(54) UNIVERSAL TIRE PRESSURE MONITORING SYSTEM TOOL AND ABSOLUTE PRESSURE COMPENSATION

(71) Applicant: ATEQ Corporation, Livonia, MI (US)

(72) Inventor: Jacques Mouchet, Shanghai (CN)

(73) Assignee: ATEQ CORPORATION, Livonia, MI (US)

(21) Appl. No.: 13/687,000

(22) Filed: Nov. 28, 2012

Related U.S. Application Data
(60) Provisional application No. 61/569,814, filed on Dec. 13, 2011.

(51) Int. Cl. B60C 23/00

(52) U.S. Cl. CPC B60C 23/00
USPC 73/146.4; 141/38

(57) ABSTRACT

An improved hand-held tire pressure monitoring system (TPMS) tool for communicating and transferring data between the tool and an onboard vehicle TPMS. The improved tool includes absolute air pressure and temperature compensation components and processes which improve the accuracy of service on a vehicle tire equipped with TPMS sensors and diagnosing TPMS error codes generated by the vehicle TPMS.

### CROSS REFERENCE TO RELATED APPLICATION

The present application claims priority benefit to U.S. provisional patent application Ser. No. 61/569,814 filed Dec. 13, 2011, the entire contents of which are incorporated herein by reference.

### TECHNICAL FIELD

The present invention is in the general field of monitoring air or nitrogen pressure and other conditions of pneumatic tires on vehicles.

### BACKGROUND

In 2007, the United States federal laws implemented and required most passenger vehicles to include a tire pressure monitoring system (TPMS) to monitor and alert drivers of low tire pressure which degrades vehicle efficiency and performance. Continued use of a tire with low tire pressure can cause premature wear of the tire and in the worst case, catastrophic tire failure.

One TPMS system is Direct TPMS. In direct TPMS, a tire sensor is installed in the wheel, often the valve stem of pneumatic vehicle tire. These sensors are capable of monitoring several conditions of the tire including: tire air/nitrogen pressure, tire temperature, wheel rotation speed and other conditions. The sensors themselves include a specific sensor identification code (ID) and are capable of receiving tools electronic signals and sending electronic signals wirelessly from inside the wheel to an electronic control unit or module (ECU) in the vehicle which typically is connected to alert signals in the instrument panel in the interior of the passenger compartment. If a wheel sensor signals a tire pressure or other condition in a tire that is above or below a predetermined level, the sensor transmits a signal that is received by the ECU and an audio/visual indication is triggered to alert the driver to the condition.

Typical tire sensors used with TPMS systems are mounted on the valve stem, strapped on the rim or they could also be mounted against the tire wall. The electronic module generally includes a small battery, a circuit board with communication antennas or coils (receive and transmit), an air pressure sensor, a temperature sensor, a rotation detection device or accelerometer, a programmable controller and a memory for storing the sensor specific ID and other information depending on the TPMS system and capabilities. Modules that do not include a battery are under development. Due to the installation inside the tire or valve stem, sensors are designed to be permanently installed within the tire. Due to the finite life of batteries, power consumption is purposely low and the sensors are initially placed in a “sleep” mode so as to not use power until the vehicle or individual wheel is installed or sold to an end user. During operation of the vehicle in the field, it is common for the sensors to not be active or continuously reporting information to the vehicle ECU, but rather to perform tire condition checks at predetermined intervals to conserve battery life. When activated, the sensors emit a signal or signals which are received and interpreted by the ECU and processed according to preprogrammed instructions.

As TPMS systems advance in capability and increased safety options are included by the vehicle original equipment manufacturers (OEMs), vehicles are capable of identifying or alerting of the specific tire that, for example, may have low tire pressure. These systems accomplish this through the vehicle ECU being initially programmed or calibrated to recognize each of the specific wheel sensors associated with a particular position on the vehicle, for example, driver front or rear and passenger front or rear. When a new vehicle is manufactured, this initial programming or calibration may take place in the vehicle assembly plant or at a later time before the vehicle is purchased or delivered to the end user.

In a conventional use of a TPMS tool, for example when the existing vehicle is driven to an OEM dealership or tire service center, the TPMS tool is typically sequentially brought into close proximity to the exterior of each tire. For each tire, the TPMS tool sends an electronic signal which is received by the adjacent sensor to activate, trigger or awaken the sensor which is in an inactive sleep mode to conserve battery power. The sensor awakens and transmits a predetermined signal or signals providing the sensor ID and other preselected information.

Depending on the type of TPMS tool, TPMS tools typically will use one or more preprogrammed tool menus for the user or technician to input or select the specific make and model of the vehicle to access preprogrammed information, for example, the recommended tire pressure for the tires of that make and model of vehicle. Depending on the capabilities of the TPMS tool and wheel sensor, other information may be transmitted and received from the TMPS tire sensor or vehicle ECU, for example, the sensor data on tire air pressure, tire air temperature, tire rotational speed, remaining sensor battery life or other conditions. An example of such a TPMS tool is the ATEQ model VT55 manufactured by ATEQ Corporation, assignee of the present invention and which is incorporated herein by reference. A reoccurring example or problem in the field occurs when a vehicle is brought into an OEM dealership or service garage because the TPMS error indicator light, typically shown on the vehicle instrument panel display, has come on alerting the driver to a potential tire problem. Because the TPMS error indicator light often does not display more specific information about the error, technicians must proceed through a series of diagnostic steps and procedures in an effort to identify the error. Due to the non-specific error code/indicator, this can be a time-intensive process of elimination for the technician.

One of the first and easiest steps to diagnose a general TPMS error indicator as described above is to check the tire air pressure in each tire and ensure the actual pressure of each tire is within the recommended guidelines for the vehicle model and tire. Typically, common tire air pressure gauges measure “gauge pressure” which is tire air pressure relative to atmospheric pressure (pressure inside the tire compared to the atmospheric pressure at the elevation where the technician is examining the tire).

Conventional TPMS tire air pressure sensors in the wheels typically measure or read “absolute pressure” (gauge/tire pressure plus atmospheric pressure) and are pre-calibrated or configured to subtract a standard constant figure from the absolute pressure read to display the tire/gauge pressure for technicians. The calibration standard or constant figure is typically determined at standard atmospheric pressure, for example, 100 kPa (14.5 psi). As such, the pre-calibrated or configured TPMS wheel sensor will tend to display a slightly different tire pressure number than the hand-held tire pressure gauge used by the technician. The TPMS wheel sensor tire pressure reading is thus perceived as inaccurate at higher elevations due to the known calibration constant or offset used. Technicians at higher altitudes typically must subtract a few pounds from the conventional TPMS wheel sensor tire absolute pressure reading to get an air pressure reading comparable to the technician-held gauge which is generally viewed by technicians as the accurate reading of the actual inflation pressure in the tire.

As the TPMS wheel sensor and the typical tire pressure tools measure pressure in different ways, and depending on the level of inaccuracy of the predetermined calibration standard, diagnosis of a TPMS error indicator is more difficult and may require additional diagnostic steps to identify the problem which is inefficient and expensive.

It would be advantageous to improve on or resolve the initial readings of tire pressure to diagnose a tire pressure problem which may be the cause of a TPMS problem indicator.

Similarly, in use, the rubber portion of passenger vehicle pneumatic tires increases in temperature due to friction with the road and vehicle braking systems. Over prolonged driving at high speeds, for example on freeways, the rubber temperature increases significantly relative to a state of rest. As a result, the air inside the sealed tires also quickly rises and falls to approximately the temperature of the tire rubber. As the tire air temperature increases, the air expands and increases the air pressure inside the sealed tire. Even without driving the vehicle, variations of ambient temperature also affect the pressure inside the tire.

If, for example, a vehicle is driven to a service center after a prolonged period of high speed driving, the TPMS or gauge pressure will test as abnormally high. A careless technician not checking or recognizing the elevated temperature of the tire may relieve some air pressure and reduce it toward the middle of the acceptable tire air pressure range for the brand and model of tire. Careless drivers may further drive a vehicle with the parking or emergency brake on which significantly raises the temperature of the vehicle brakes which dangerously increases the temperature of the brake components, wheel rotor and the adjacent tire.

Similarly, if a vehicle has been sitting idle for an extended period of time or in colder temperatures, the air inside the tire reduces in volume producing a lower tire air pressure reading. A careless technician may add air pressure to again achieve a middle range of acceptable air pressure for that tire.

Modern vehicle onboard TPMS devices are programmed to alert a driver when the tire air pressure rises or falls approximately 20% above an optimum or recommended tire air pressure. In the above examples of elevated or lower tire temperatures, a careless or unknowing technician may add or relieve air pressure placing the tire air pressure near the +/−20% warning point of the TPMS. Once the temperature of the tire achieves a normal or ambient state and temperature, the tire air pressure falls or rises beyond the +/−20% limit and the TPMS illuminates the warning light alerting the driver to a problem condition with one or more of the tires. This is a common problem in the field. Only experienced or careful technicians typically take into consideration the temperature of the tire and/or consider the temperature of the environment the vehicle was recently exposed to.

It would be advantageous for a TPMS tool to measure or gauge the temperature of the tire rubber, and therefore the temperature of the air inside the tire, to alert the technician to elevated or artificially low temperatures of the vehicle tires so a proper amount of air pressure can be added, reduced or not changed. This improves the service provided by technicians, reduces the amount of TPMS tire pressure warnings to the driver.

It further would be advantageous to use and configure TPMS tools to quickly access stored information and visually display relevant information on tire pressure for the vehicle being examined and to read and/or convert and display tire pressure readings the same or substantially equivalent to the reading of pressure by the TPMS wheel sensor. It would be further advantageous to display TPMS values on the tool or related devices which are easy for technicians to understand and quickly disclose and remedy error indicators and tire problems.

It would be further advantageous to configure a TPMS tool to physically connect to the valve stem of a vehicle tire and read tire air pressure in the advantageous manner described above and to add or release air pressure as needed to conform to vehicle specifications to quickly and efficiently resolve fundamental causes of a TPMS error indicator.

### BRIEF SUMMARY

The present invention provides examples of improvements to existing TPMS tools including additional components, features, functions and methods of operation described below.

In one example, the TPMS tool is designed and configured to read, calculate and/or display vehicle tire pressure in absolute pressure as conventional TPMS wheel sensors.

In one example, the TPMS tool is configured to initially or quickly display visual menus to input the TPMS error indicator eliminating conventional menus and steps to quickly diagnose the error indicator. In one example, tire pressure information and diagnostic steps are retrieved from the tool memory and displayed to aid the technician.

In another example, the TPMS tool is designed and configured to physically connect to the tire and provide additional air pressure through connection to a peripheral device, for example an air compressor, or release air pressure from the tire through the TPMS tool until the pressure is within predetermined and recommended pressure standards.

In another example, the TPMS tool may include a temperature sensor for comparison and display in the same or substantially the same manner as a temperature reading by the TPMS wheel sensor as another step to more efficiently diagnose TPMS error indicators for the technician.

In another example the TPMS tool includes a tire temperature device for determining the tire exterior temperature through an infrared, laser or other measuring device. In one example the tool includes an audio and/or visual alarm to advise of a high or other abnormal tire temperature.

### BRIEF DESCRIPTION OF THE DRAWINGS

The description herein makes reference to the accompanying drawings wherein like reference numerals refer to like parts throughout the several views, and wherein:

FIG. 1 is a perspective view of an example of a prior art TPMS tool;

FIG. 2 is a partial perspective end view of the example TPMS tool in FIG. 1;

FIG. 3 is a schematic, partially cut-away illustration of an example of a TPMS tool of the present invention including an exemplary pressure sensor and controller;

FIG. 4 is a schematic partially cut-away illustration of an example of a TPMS tool having a tire temperature measurement device;

FIG. 5 is a schematic perspective view of an exemplary cradle accessory usable with the TPMS tool in FIGS. 1 3 or 4;

FIG. 6 is a schematic flow chart of an example of a method for using initial TPMS tool display menus to diagnose a TPMS error indicator from a vehicle; and

FIG. 7 is a schematic flow chart of an example of a method for reading, comparing and displaying measured vehicle tire absolute air pressure and temperature and compensation tire air pressure based thereon.

### DETAILED DESCRIPTION OF EXAMPLES OF THE INVENTION

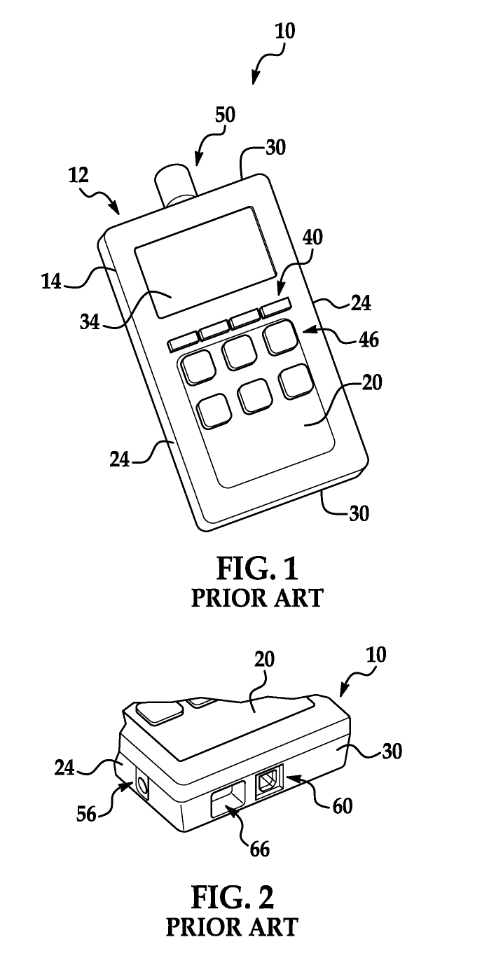

Referring to FIGS. 1-7 examples of an improved universal TPMS tool and methods are illustrated and described below.

Referring to FIGS. 1 and 2, an example of a prior art tire pressure monitoring system (TPMS) tool 10 for use with TPMS systems installed in passenger vehicles is illustrated. Referring to FIG. 1, the exemplary TPMS tool 12 is a hand-held, mobile device including a housing 14 having front face 20, sides 24 and top and bottom ends 30. In the example, front face 20 includes a visual liquid crystal display (LCD) panel, several indicator lights 40, a pushbutton keypad 46 and an antenna 50. In the example, antenna 50 is a low frequency (LF) antenna. Other antennas for transmitting and receiving other frequencies and signals known by those skilled in the art may be used. In a typical application, TPMS tool 12 is used to send, receive and process electronic data with a TPMS system installed in a passenger vehicle (not shown) by sending and receiving modulated or pulsed (continuous) wave signals. Information is coded or decoded in the form of a modulated signal, known in the art algorithm such as Manchester ASK, or other types that may be used, in accordance to corresponding TPMS system communication protocol specification and implemented using the Tool microprocessor 80 and a memory storage device 86. It is understood that the housing 14, front face 20, visual display 34 can take different configurations, forms and functions as known by those skilled in the field.

Referring to FIG. 2, exemplary tool 10 may include an AC or DC power connection, a first 60 and a second 66 data communication port for sending and receiving electronic signals and data from peripheral devices (not shown) or to the vehicle ECU through a wired or wireless connection. Other communication ports and connections known by those skilled in the art may be used.

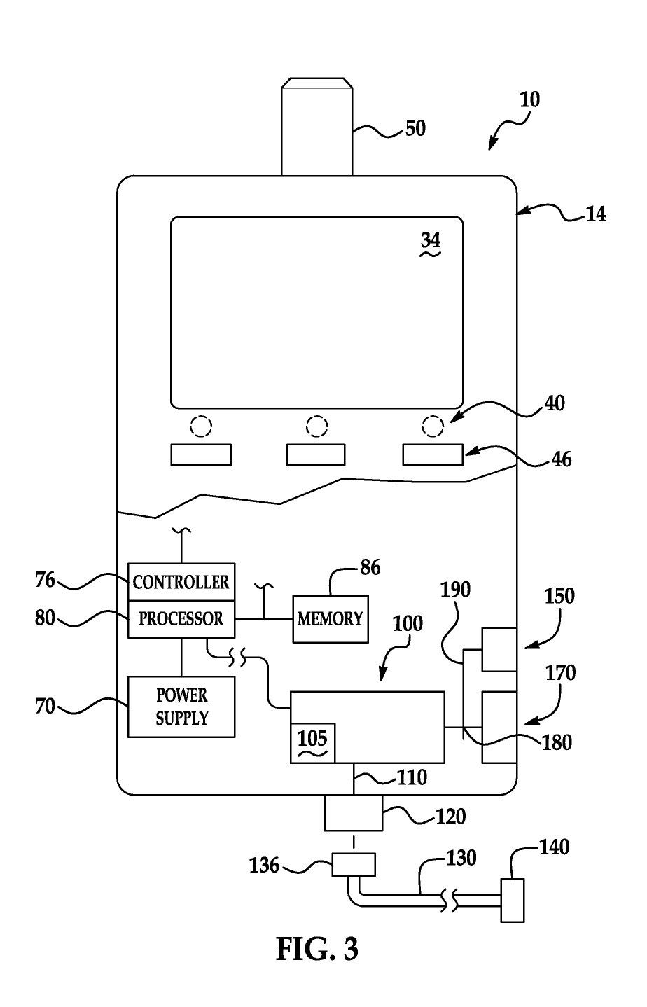

Referring to FIG. 3, exemplary tool 12 may include an internal power supply 70 connected to a controller 76, a microprocessor 80 and a memory storage device 86. Power supply 70 may be conventional batteries, a rechargeable battery or other internal power means known by those skilled in the art. Where components in conventional devices may be used in the present invention, the same indicator numbers are used.

In the example shown in FIG. 3, an exemplary tire air pressure compensation device 100 is used internally in the tool housing 14 and is in communication with the power supply 70, controller 76, processor 80 and/or memory 86 in a manner known by those skilled in the art. Pressure device 100 is used along with other components of the tool 12 to read, calculate, compensate and/or adjust the vehicle tire air pressure, for example, to initially diagnose a TPMS error indicator or otherwise measure and adjust the tire air pressure.

In the example, pressure device 100 is in fluid communication with a pressure port 120 extending from the housing 14 through an air line 110 as generally shown. A suitable valve (not shown) in line 110 may be used to suit the particular application. Port 120 is configured to accept an air hose 130 having suitable air/fluid-type connectors 136 for connection to port 120 and connector 140 to the valve stem of the vehicle tire (not shown) which is in fluid communication with the air inside the vehicle tire. Port 120 may be suitable for direct connection to the vehicle valve stem, but a quick-connect hose 130 is preferred so the visual display 34 of tool 10 can remain in easy view for a technician. Although shown extending from housing 14, port 120 may be flush with the housing perimeter or take other locations and configurations on housing 14 as known by those skilled in the art.

In the example, tool air pressure compensation device 100 is further in fluid communication to an air input port 150 and an air discharge port 170 as generally shown. Input and discharge ports are connected to device 100 by air lines 190 and includes a pressure valve 180 between the ports and the device 100 for selective transmission of pressurized air between the vehicle tire and device 100. In one example, valve 180 is a solenoid-type valve that is in electronic communication with the device 100 and/or processor 80 and controller 76 for selective opening and closing of the valve 180 to allow input or discharge of compressed air. In the example shown, tool air pressure device 100 includes an absolute pressure sensor 105 which is used to measure absolute pressure in the same or similar manner as the TPMS wheel sensor. Sensor 105 may be internal to the tool housing 14 or may be on the exterior of the housing (not shown).

In the example, absolute pressure sensor 105 is in fluid communication with port 120 to selectively receive pressurized air from a vehicle tire to calculate absolute pressure (gauge pressure+atmospheric pressure) and display the calculated absolute pressure in the same or similar manner as the TPMS wheel sensor. Sensor 105 may be one of many conventional sensors used to measure fluid/air pressure known by those skilled in the art. It is understood that ports 120, 150 and 170 may be combined into fewer ports with combined functions, as well as alternate air lines and valving known by those skilled in the art, to achieve the features, functions and objectives described.

In this manner, the example TPMS tool 12 may provide a direct comparison of tire air pressure as manually measured and transmitted from the TPMS sensor. In a preferred example, the tool 12 visually displays the two tire pressure readings for the technician to review. If the as measured pressure from the TPMS sensor is within a reasonable range as the absolute pressure measurement taken by the tool 12, this provides the technician with a verified tire pressure and that the tire pressure function of the wheel sensor is operating correctly.

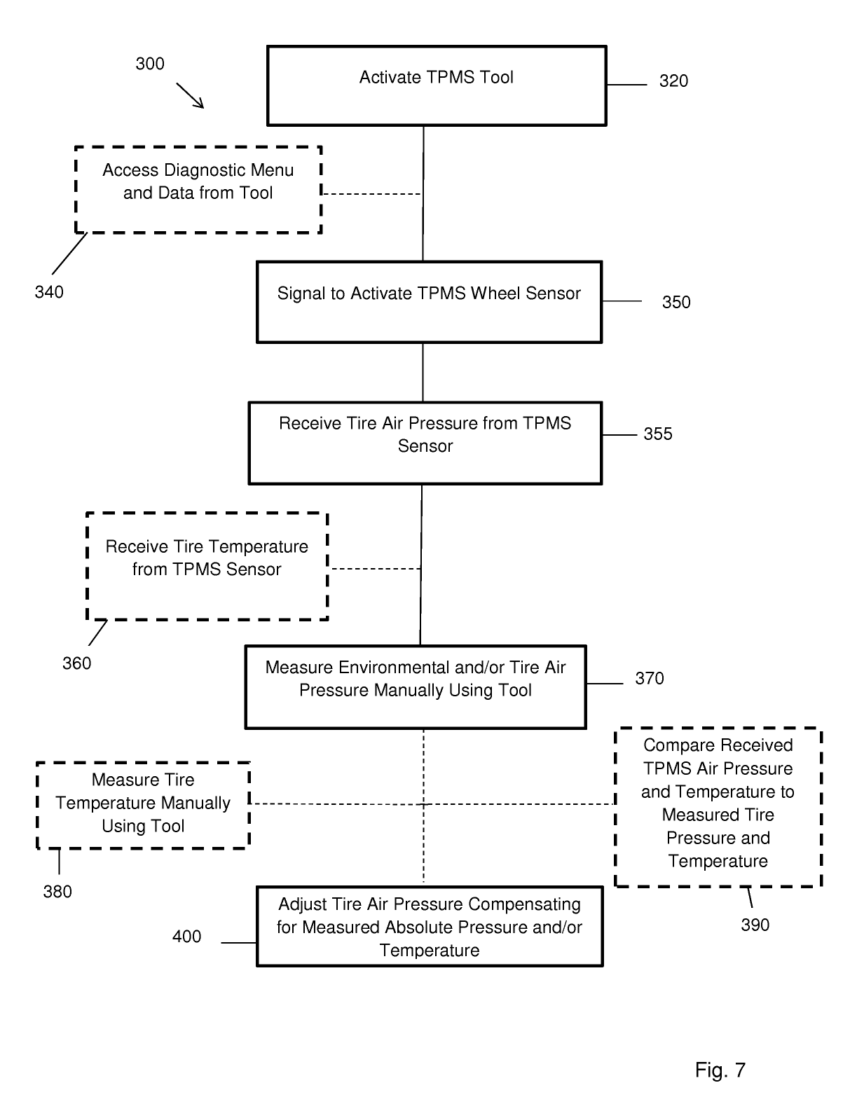

In one example, the process of which is described further below and illustrated in FIG. 7, the tool 12 and device 100 can be used to add or remove/discharge air pressure from a vehicle tire through exemplary ports 150 and 170 as generally described above. In the example, if the pressure reading by sensor 105 is below the recommended tire air pressure standard, a peripheral device, for example and air compressor, can be connected to air inlet port 150 and add pressurized air through the port 120 and hose 130 connected to the valve stem of the vehicle tire. The amount of air that is allowed to pass through port 120 and into the vehicle tire can be monitored by the tool and indicated on the visual display. Once the air pressure standard is met for the particular vehicle or tire, which may be stored in the tool memory, the tool can close the valve 180 to prevent further air from passing through the tool into the vehicle tire. Once the standard or proper tire air or nitrogen pressure is achieved, or a maximum pressure is reached, valve 180 can be opened and excess air can pass through discharge port 170 until the compressor is turned off or the high pressure condition is relieved. It is understood that measurement of the absolute pressure through tool sensor 105 may be achieved without the components 150, 170 and related components and features described immediately above.

Similarly, if the tire pressure taken through hose 130 and port 120 as determined by pressure sensor 105 is higher than the vehicle or tire pressure standards, device 100 can selectively open discharge port 170 to allow and control excess air to be discharged from the vehicle tire through the tool. When the tool senses that the tire pressure is back within the standards, valve 180 may be selectively closed thereby preventing further air from discharging from the tire. As noted, ports 120, 150, 170 and the air lines and valves may take different forms and configurations known by those skilled in the field without deviating from the present invention.

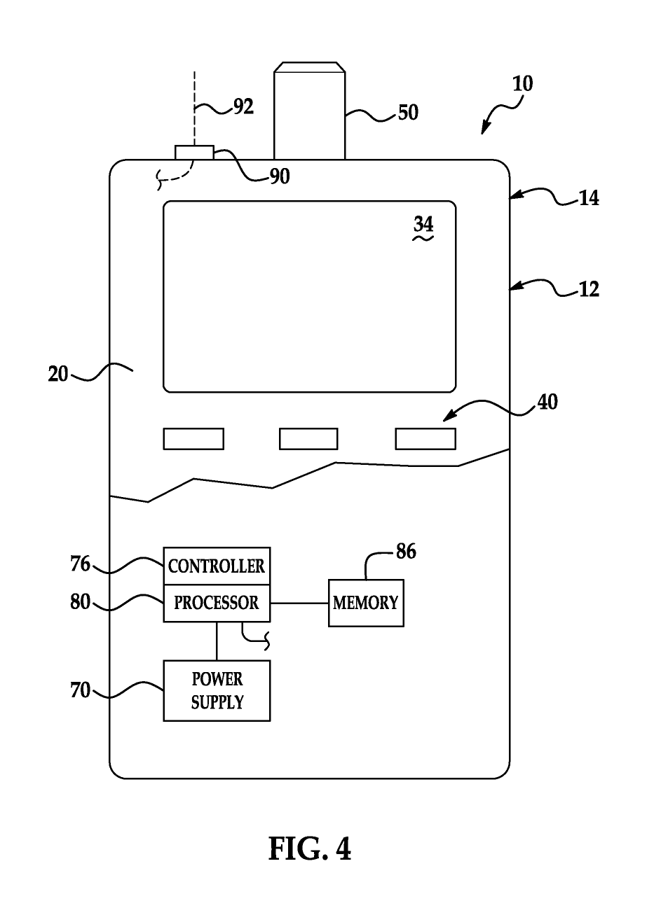

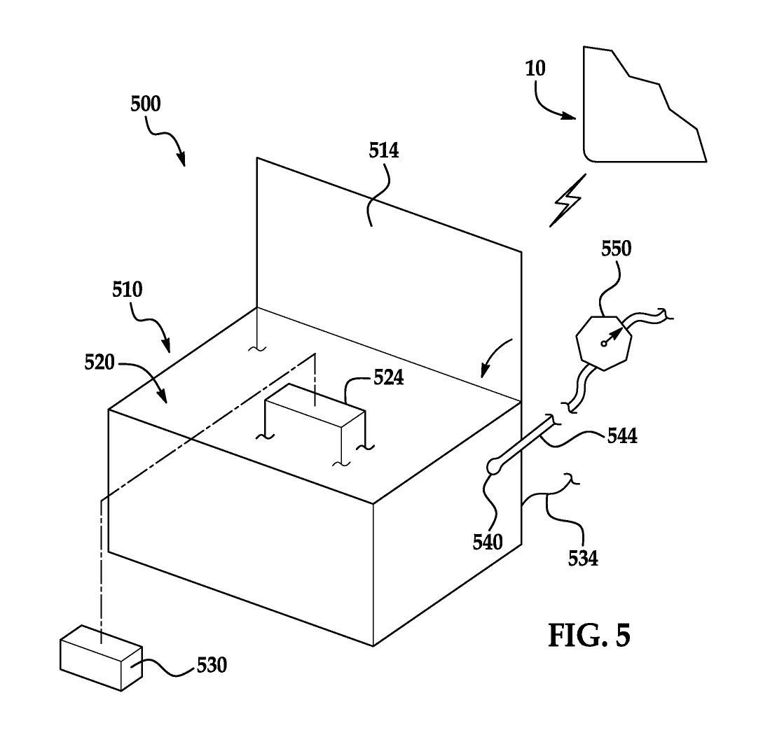

In one example shown in FIG. 4, tool 12 may further include a temperature compensation device including sensor to measure or read the environmental temperature where a vehicle is being serviced or, in other examples, take a temperature reading of the exterior of the tire or of the air inside the vehicle tire being examined for comparison to the temperature measurement as taken by the TPMS wheel sensor. In one example, ambient or environmental temperature can be taken by a sensor positioned on the exterior of the tool housing 14 and communicated to the processor 80 and/or controller 76 for visual display on screen 34. Where the tire air temperature inside the tire is manually measured or taken, port 120 and hose 130 may be used to receive a sample of air from the tire and the temperature of the tire air can be measured through a sensor (not shown). Alternately, an independent device (not shown) could be used to measure the temperature of the air inside or outside the tire and the value electronically transmitted or manually input into the tool 12 through the keypad 46. The value would then be used by the processor for further calculation and displays. The measured internal tire air temperatures can be compared to the TPMS temperature reading that is wirelessly transmitted to the tool 12 for use by the technician to check the status of the tire and the TPMS wheel sensor as another diagnostic tool and procedure.

In an example shown in FIG. 4, tire temperature sensor 90 is used to measure the temperature of the rubber on the outside of the tire. In one example, temperature sensor 90 is an infrared or laser sensor that selectively projects a beam 92 to the sidewall of a vehicle tire. The sensor 90 detects the temperature of the tire to determine if the tire temperature, and the air temperature inside the tire, is within a normal operating range, an abnormal range and/or is reasonably consistent with the TPMS sensor temperature reading. This is another possible TPMS diagnostic step. The sensor 90 is in electronic communication with the other components of tool 12 and can be displayed on screen 34.

An exemplary process of use of tool 12 having absolute pressure and temperature compensation is illustrated in FIG. 7. In addition to a diagnostic check of the TPMS sensor, a tire temperature measurement is useful to the technician if air pressure needs to be added or reduced in the tire. In one example, tool 12 can use the various temperature readings (TPMS, internal air measurement, exterior tire temperature measurement, environment temperature measurement) and can calculate an adjustment factor or compensation based on temperature and/or atmospheric air pressure for the technician so the proper tire air pressure is applied by the technician.

Although the above temperature measuring and compensation steps are shown with the absolute pressure measurement steps, it is understood that the absolute pressure and temperature measurement components, calculations, displays and method steps can be separate and independent processes and tool 12 can employ one without the other, or neither process. It is understood that other means for measuring temperature and air pressure of the vehicle tire and other tire conditions known by those skilled in the art may be used.

In another example not shown, the tool 10 may further include a partial or full set of diagnostic procedures from the vehicle original equipment manufacturer (OEM) for diagnosing or troubleshooting TPMS error codes or common problems. There may be a set of such instructions or aids for each particular vehicle or where the same for a particular OEM, one for each OEM. This data, instructions and/or visual aids may be downloaded wirelessly or through a cable into the tool 10 and stored in the tool memory 86 for recall by the technician through predetermined menus or keypad 46. Other ways to load or store the data or instructions known by those skilled in the art may be used. In an alternate example, the OEM diagnostic instructions or data may further advise through visual displays or other indicators that the particular TPMS tool 10 is capable of carrying out one or more of the predetermined diagnostic procedural steps to assist the technician or whether alternate equipment or processes beyond the tools capability will be needed to conduct the diagnostic step or steps.

Referring to FIG. 5, an alternate example of tool 10 illustrating an exterior or accessory cradle 500 for use with tool 12 is illustrated. In the example, cradle 500 includes a sealable enclosure or box 510 having bottom, sides and closeable lid 514 defining an interior chamber 520. Inside chamber 520 is a stand or support 524.

In one example, cradle 500 is used along with system 10 and tool 12 to program programmable TPMS sensors 530, for example Schrader EZ, Orange or Alligator brand programmable TPMS sensors. In the example, when a programmable sensor 530 needs to be initially programmed, checked or reprogrammed, the sensor can be placed on the stand 524 and then placed in communication with the tool 12 or other device. This can be done wirelessly or through an electronic communication cable 534 connectable with tool 12 as known by those skilled in the art. In an application where the sensor 530 needs to be pressure tested to ensure that it is programmed and functioning properly, box 510 can be closed and locked shut. An air port 540 extending through one of the box 10 walls and in fluid communication with chamber 520 may be used to input pressurized air from an exterior air source (not shown) through an air line 544. Through use of the tool 12, and alternately another pressure gauge 550 connected to air line 544, the sensor 540 can be checked to verify that it is measuring and sending a proper signal to the tool 12. Other uses of cradle 500 for devices other than programmable TPMS sensors known by those skilled in the art may be used.

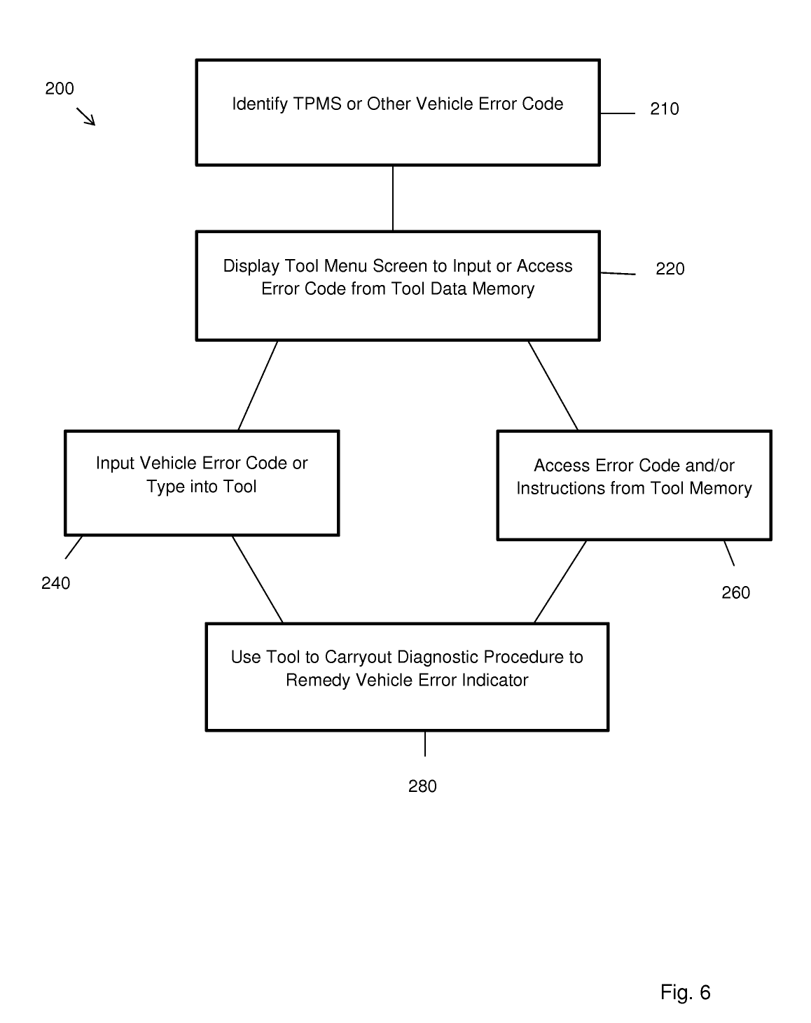

In an exemplary process 200 shown in FIG. 6, tool 12 preferably includes graphic user interface menus visible on tool screen 34 by a technician. In one example, the tool 12 is used to quickly carry out a series of diagnostic steps relating to the vehicle's tire pressure or temperature in an attempt to quickly diagnose a non-specific TPMS error indicator.

In step 210, a technician identifies a vehicle TMPS error indicator light, typically visible from a vehicle instrument panel as described above. In the example, the vehicle does not provide further visual information, for example, what the cause of the TPMS error is. In step 220, instead of requiring a technician to input or select general information from stored information in tool memory 86, for example the vehicle type, model year etc. as is conventional, the tool 112 provides a first or quickly accessible menu interface to troubleshoot the error and quickly resolve it. In the example, the tool 12 automatically displays a troubleshoot screen or with a simple activation button or other selection, retrieves the troubleshoot menu/interface from tool memory 86.

In one example, step 240 includes a user interface allowing the technician to input the error code information that is available from the vehicle. This for example can be input through keypad buttons 46. On basic vehicle models, the available error information may only be the TPMS error indicator (yellow tire tread with exclamation symbol). Where the tool includes a touch screen, the basic symbol can be included on the interface and simply touched by the technician. On more expensive and sophisticated vehicles, the vehicle may provide more information which can be manually input or selected from other predetermined icons on the interface.

In an alternate example, step 260 provides a user interface allowing the technician to quickly access common TPMS error indicator information stored in memory 86 which can be recalled and displayed on the graphic interface. In either alternative 240 or 260, the tool 10 allows the technician to immediately focus in on the error indicator or code in an attempt to find a quick solution or to quickly eliminate some potential solutions which are not causing the error indicator.

In step 280, the tool 12 provides instructions or guidance on diagnosing the cause of the identified and input TPMS error code. This, for example, may provide the most common causes of the input error code, for example improper tire pressure described below, provide a recommended sequence or sequences for the technician to step through to most efficiently determine the cause of the problem and resolve it.

Referring to FIG. 7, an example of a process 300 to initially check the tire pressure in response to a TPMS error code, using absolute pressure, is illustrated. As explained above, often the easiest and least expensive cause of a TPMS error indicator is that one or more of the vehicle's tires has air pressure below the recommended standards triggering a warning signal by the wheel sensor thereby alerting the engine control unit (ECU) which triggers the indicator light to the driver. It would be highly advantageous to have an improved TPMS tool 12 process to quickly and accurately identify a tire air pressure problem which may be causing the TPMS error indicator.

In the example process when a vehicle is brought into a service center with a TPMS error, the tool 12 is activated in step 320 which may promptly display, or allows for easy and rapid access by a technician a troubleshoot interface on screen 34 as described above in step 220 in FIG. 6. In the example illustrated in FIG. 6, the optional troubleshoot interface/screen in step 340 is a tire pressure diagnostic screen or menu. In an optional step 340, the technician my access additional information, for example more detailed information and diagnostic steps relating to tire pressure, from the tool memory 86.

In step 350 the tool 12 is used to activate or “awaken” the TPMS sensor enabling the sensor to communicate and send data to the tool 12. In step 355, the TPMS sensor transmits the tire air pressure (typically in absolute pressure) to the tool 12. Many TPMS sensors also transmit tire temperature which may be included as a step 360.

In step 370, the tool 12 is used to measure and calculate the absolute pressure in one or more of the vehicle tires using the pressure device 100 and sensor 105 as described above and illustrated in FIG. 3. This may be accomplished by the sensor 105 measuring the environmental atmospheric air pressure in the location of the service center and directly measuring the tire air pressure through an air hose 130 connectable to the tool 12. Alternately, a separate device (not shown) may manually measure the tire air pressure and this value can be input into tool 12 through the keypad 46. These numbers would be combined to determine the absolute air pressure using tool 12. Other ways of measuring atmospheric air pressure and tire air pressure known by those skilled in the art may be used.

In optional step 380 the temperature of the tire may be measured in one of the several ways described above, for example through beam sensor 90. Optionally, or in addition, the environmental temperature is taken by tool 12 or may be input into tool 12 through keypad 46.

In exemplary step 390, the received tire air pressure and temperature from the TPMS sensor is compared to the manually measured tire air pressure and temperature and is displayed on display screen 34 for review by the technician. If, for example the absolute air pressure and temperature measurements received from the TPMS sensor are within a reasonable range of the measured absolute air pressure and temperature, this indicates to the technician that the TPMS sensor is operating properly, an important diagnostic step.

In an optional step (not shown), tool 12 may provide an audio or visual indicator to the technician if the compared numbers are within an acceptable range. For example, a positive indicator, for example the two numbers are within a reasonable range to verify their accuracy, or provide a negative indicator, that the variance between the numbers signals a problem to alert the technician. This may require repeating the process or may indicate that the sensor (or tool) pressure readings are faulty or erroneous.

In an optional step (not shown) a comparison of the verified absolute air pressure and/or temperature figures are compared to the standard or recommended tire pressure figures. In a preferred example, reference tables or data stored in the tool data storage device 86 and the results are displayed on the screen 34 advising the technician that the measured pressure is within or outside of the recommended pressure and possibly the cause of the TPMS error indicator. However, in the interests of rapid identification of a tire pressure problem and/or a less complex and lower cost tool 12, a predetermined range may be set as a go-no-go or pass/fail system to quickly identify or rule out the tire pressure is causing the TPMS error. For example, a predetermined range of 25-45 pounds per square inch (psi) (gauge pressure) (39.5-59.5 psi) (absolute pressure) could be set and stored in memory as acceptable tire pressures which would not trigger a TPMS error indicator on passenger vehicles. If the verified measured pressure falls within the range, there would be a high level of confidence that the tire pressure is not causing the TPMS alert and advancement to the next diagnostic steps can proceed. Conversely, if a tire is outside of the range, the problem is identified in a matter of minutes and avoids many of the standard, time-consuming protocols and sequences of conventional TPMS tools and operations.

In step 400, if necessary, the technician adjusts the tire air pressure compensating for the measured absolute pressure and temperature. As described above, the tool may calculate and display a compensation factor or adjustment taking into account the measured absolute tire air pressure and/or temperature to more accurately provide the time with the proper tire inflation. These features and step reduce the inaccuracies described in the Background, for example at high elevations or in situations where abnormal tire temperatures are experienced at service stations.

In optional steps (not shown), and where a TPMS tool includes the pressure device 100 and input 150 and discharge 170 ports, the tool 12 can be used add or discharge air pressure into vehicle tires. Where tool 12 is connected to a tire through hose 130, and a low pressure condition is established by the tool 12 in the manner described above, step 440 may include a prompt on the visual display 34 or an audible indicator, for the technician to add air to, or discharge air from, the tire.

It is understood that additional steps, or an alternate order of steps, known by those skilled in the art may be used.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A tire pressure monitoring system (TPMS) tool comprising:
a hand-held portable housing having opposing sides and ends defining a front face;
a power source, a programmable processor, a data storage device and at least one antenna adapted for wirelessly receiving at least tire air pressure data from a TPMS sensor connected to a vehicle tire; and
a tire air pressure compensation device connected to the tool housing for compensating the tire air pressure inside the vehicle tire based on the environmental atmospheric air pressure around the tire.

2. The tool of claim 1 wherein the tire pressure compensation device further comprises a tire absolute air pressure measuring device connected to the tool housing and in electronic communication with at least one of the tool processor and memory, the absolute air pressure measuring device adapted for measuring the tire air pressure in terms of absolute air pressure.

3. The tool of claim 2 wherein the tire absolute air pressure measuring device further comprising an absolute tire pressure sensor positioned inside the tool housing, the absolute tire pressure sensor having an atmospheric air pressure sensor and a tire gauge pressure sensor adapted to receive pressurized air from the vehicle tire.

4. The tool of claim 3 further comprising a program stored in the tool memory for comparing the measured absolute tire air pressure of the vehicle tire to the tire air pressure data received from the TPMS sensor.

5. The tool of claim 2 further comprising a visual display screen, the absolute air pressure measuring device operable to selectively display the measured tire absolute air pressure on the tool display screen.

6. The tool of claim 1 further comprising a tire temperature compensation device, the temperature compensation device operable to compensate the tire air pressure relative to temperature.

7. The tool of claim 6 wherein the tire temperature compensation device further comprises a temperature sensor for measuring the temperature of the tire.

8. The tool of claim 7 wherein the temperature sensor comprising a receiver connected to the tool housing for receiving a tire temperature data from the TPMS tire sensor.

9. The tool of claim 8 wherein the temperature sensor further comprising a beam temperature sensor having a beam projectable from the tool housing to an exterior of the tire, the receiver adapted to receive the beam reflected from the tire including temperature data of the tire exterior.

10. The tool of claim 9 wherein the temperature sensor comprising an environmental temperature sensor for measuring the environmental temperature around the tool.

11. The tool of claim 10 further comprising a program stored in the tool data storage memory for calculating a tire pressure compensation offset based on the measured temperature.

12. A tire pressure monitoring system (TPMS) tool comprising:
a hand-held portable housing having opposing sides and ends defining a front face;
a power source, a programmable processor, a data storage device and at least one antenna adapted for wirelessly receiving at least tire air pressure data from a TPMS sensor connected to a vehicle tire; and
a display screen having a graphic user interface.

13. The tool of claim 12 further comprising a graphic user interface for selectively displaying a plurality of preprogrammed TPMS error codes and remedial instructions for each respective code selectively accessible from the tool data storage device.

14. The tool of claim 12 further comprising a sealable cradle enclosure for selective engaging receipt of a programmable TPMS sensor, the cradle defining an interior cavity in selective electronic communication with the tool.

15. The tool of claim 14 further comprising a port for selective receipt of pressurized air into the cradle cavity.

16. A method of diagnosing a tire pressure monitoring system (TPMS) error code through use of a tire pressure monitoring tool, the method comprising:
identifying a tire pressure monitoring system error code;
displaying a graphic user interface on a visual screen of the tool for troubleshooting an error code by the TPMS;
inputting or selecting the error code into the interface;
retrieving data from a tool data storage device directed to resolving the error code; and
using the tool to remedy a tire condition causing the error code.

17. The method of claim 16 further comprising the step of:
comparing a tire air pressure data received from a TPMS tire sensor by the tool with a measured absolute tire air pressure obtained by the tool.

18. The method of claim 17 further comprising the step of:
comparing a tire temperature data received from the TPMS tire sensor by the tool with a measured temperature of at least one of a pressurized air in the tire or an exterior of the tire.

19. A method of determining a vehicle tire air pressure in a tire pressure monitoring system (TPMS), the method comprising the steps of:
receiving a tire air pressure and tire temperature data from a tire TPMS sensor;
measuring an absolute tire air pressure from a sample of pressurized air from the vehicle tire;
measuring at least one of a temperature of the tire air pressure from pressurized air in the tire or the a temperature of the exterior of the tire;
comparing the received air pressure data from the TPMS sensor with the measured absolute tire pressure;
comparing the received tire temperature data from the TPMS sensor with the measured temperature of the at least one of pressurized air in the tire or the exterior of the tire; and
alerting a tool user to the tire air pressure and tire temperature comparisons.

20. The method of claim 19 wherein the steps of comparing the air pressure and comparing the tire temperature each further comprise comparing at least one of the received or the measured tire air pressure or temperature with preprogrammed standard pressures or temperatures stored in the tool data storage device; and
adjusting the air pressure in the tire based on at least one of the measured absolute tire air pressure or the measured tire air temperature or the measured temperature of the exterior of the tire.
